(19) United States
(12) Patent Application Publication
(10) Pub. No.: US 2016/0043358 A1
(43) Pub. Date: Feb. 11, 2016

(54) SECONDARY BATTERY

(71) Applicant: SAMSUNG SDI CO., LTD., Yongin-si (KR)

(72) Inventor: Min-Hee JOO, Yongin-si (KR)

(21) Appl. No.: 14/818,720

(22) Filed: Aug. 5, 2015

(30) Foreign Application Priority Data
Aug. 8, 2014 (KR) 10-2014-0102376

(51) Int. Cl. H01M 2/02; H01M 10/04

(52) U.S. Cl. CPC H01M 2/0217; H01M 10/0431; H01M 2/024

(57) ABSTRACT

A secondary battery includes an electrode assembly including a first electrode plate, a second electrode plate facing the first electrode plate, and a separator between the first electrode plate and the second electrode plate, and a case accommodating the electrode assembly, wherein the first electrode plate includes a first base material having a sloped end and a first active material layer positioned on the first base material, the first active material layer having a sloped end.

### CROSS-REFERENCE TO RELATED APPLICATION

Korean Patent Application No. 10-2014-0102376, filed on Aug. 8, 2014, in the Korean Intellectual Property Office, and entitled: “Secondary Battery,” is incorporated by reference herein in its entirety.

### BACKGROUND

1. Field

Embodiments relate to a secondary battery.

2. Description of the Related Art

Various secondary batteries are used as a power source of portable electronic devices. As portable electronic devices are increasingly used in various fields, the demand for secondary batteries has rapidly increased. Secondary batteries can be charged and discharged so as to be used a plurality of times and are effective economically and environmentally.

### SUMMARY

Embodiments are directed to a secondary battery including an electrode assembly including a first electrode plate, a second electrode plate facing the first electrode plate, and a separator between the first electrode plate and the second electrode plate, and a case accommodating the electrode assembly. The first electrode plate includes a first base material having a sloped end and a first active material layer positioned on the first base material, the first active material layer having a sloped end.

The sloped end of the first base material and the sloped end first active material layer may be sloped at opposing angles to each other.

The second electrode plate may include a second base material having a sloped end, a second active material layer on the second base material and having a sloped end, and a stacked member on the second base material partially overlapping the second active material layer and having a sloped end.

The stacked member may be a lamination tape.

The stacked member may include a first sloped end and a second sloped end.

The first sloped end of the stacked member may be located on the second base material and may slope in a direction identical to a sloping direction of the sloped end of the second active material layer. The second sloped end of the stacked member may be located in an overlapping relationship to the second active material layer and may slope in a direction opposite to the sloping direction of the sloped end of the second active material layer.

Directions in which the sloped end of the first base material and the sloped end of the second base material slope may be opposite to each other.

The second active material layer and the stacked member may be located on both sides of the second base material.

An extending length of the second active material layer and the stacked member located on one surface of the second base material may be different from an extending length of the second active material layer and the stacked member located on an opposite surface of the second base material.

The first electrode plate, the second electrode plate. and the separator may be in a wound state.

A slope of the sloped end of the first base material and a slope of the sloped end of the first active material layer each form an angle in the range of about 10° to about 80° with respect to a direction in which the first base material extends.

An end of the first electrode plate may be positioned at a shorter side portion among a longer side portion and the shorter side portion of the electrode assembly.

The first base material may include a first region and a second region. The first active material layer may be located in the first region. The second region is a first uncoated portion.

The second base material may include a first region and a second region. The second active material layer may be located in the first region. The second region may be a second uncoated portion.

A boundary between the second active material layer and the second uncoated portion may have a waveform shape.

### BRIEF DESCRIPTION OF THE DRAWINGS

Features will become apparent to those of skill in the art by describing in detail exemplary embodiments with reference to the attached drawings in which:

FIG. 1 illustrates an exploded perspective view of a secondary battery according to an embodiment;

FIG. 2 illustrates an exploded perspective view of an electrode assembly of the secondary battery illustrated in FIG. 1;

FIG. 3 illustrates a cross-sectional view of a first electrode plate of the electrode assembly of the secondary battery illustrated in FIG. 1;

FIG. 4 illustrates a plan view of a process for manufacturing a second electrode plate of the electrode assembly of the secondary battery illustrated in FIG. 1; and

FIG. 5 illustrates a cross-sectional view of a second electrode plate of the electrode assembly of the secondary battery illustrated in FIG. 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

It is to be understood that, although the terms “first”, “second”, etc., may be used herein to describe various elements, these elements should not be limited by these terms. These terms are only used to distinguish one element from another element. In describing the current embodiment, when it is determined that detailed description of a well-known function or configuration blurs the subject matter, detailed description thereof will not be given.

Hereinafter, embodiments will be described in detail with reference to the accompanying drawings.

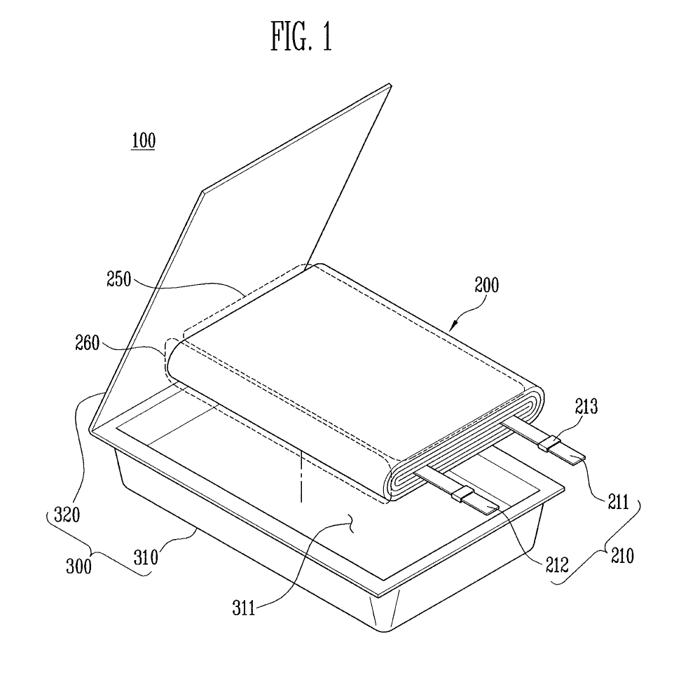

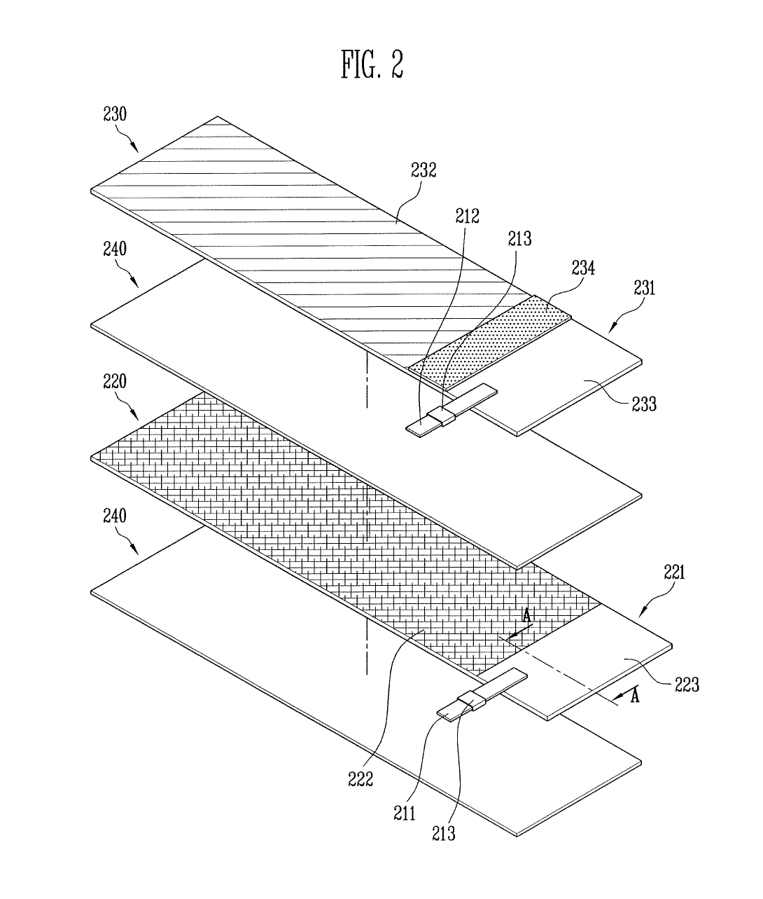

FIG. 1 illustrates an exploded perspective view of a secondary battery 100 according to an embodiment. and FIG. 2 illustrates an exploded perspective view of an electrode assembly 200 of the secondary battery 100 illustrated in FIG. 1. Hereinafter, the secondary battery 100 according to this embodiment will be described with reference to FIGS. 1 and 2.

As illustrated in FIGS. 1 and 2, the secondary battery 100 according to this embodiment may include an electrode assembly 200 including a first electrode plate 220, a second electrode plate 230, and a separator 240, and a case 300 accommodating the electrode assembly 200. The first electrode plate 220 may include a first base material 221 having an end that is cut to be sloped and a first active material layer 222 having an end that is cut to be sloped. For example, terms such as “sloped,” “cut to be sloped,” “sloping,” etc. may refer to a configuration in which a thickness of a base material or material layer decreases in a tapered, linear manner at an end thereof. For example, as shown in FIG. 3, one surface of the base material or material layer may extend in a direction farther than an opposite surface of the base material or material layer, and an angled surface may connect the one surface with the opposite surface.

The electrode assembly 200 may include electrode tabs 210 on one side thereof The electrode assembly 200 forms the secondary battery 100 together with the case 300. The electrode assembly 200 generates electrochemical energy through ion or electron transfer.

The electrode assembly 200 may include the first electrode plate 220, the second electrode plate 230, the separator 240 interposed between the first electrode plate 220 and the second electrode plate 230. and the electrode tabs 210 including a first electrode tab 211 and a second electrode tab 212. The first electrode tab 211 and the second electrode tab 212 may be drawn outwardly from the electrode assembly 200. The electrode tabs 210 may be drawn from one side of the electrode assembly 200 to transmit electrochemical energy generated from an interior of the secondary battery 100 to the outside, for example, to a protective element, or the like. The first electrode plate 220 and the second electrode plate 230 may react with an electrolyte within the case 300 to generate a flow of current or electrons, and a current or electrons may be transmitted to the outside through the electrode tabs 210. The electrode assembly 200 may be manufactured by interposing the separator 240 between the first electrode plate 220 and the second electrode plate 230 and winding the separator 240, first electrode plate 220, and second electrode plate 230. In preparing the electrode assembly 200 to have the winding shape, two separators 240 may be used as illustrated in FIG. 2. The secondary battery 100 may be manufactured by accommodating the electrode assembly 200 together with an electrolyte in the case 300.

The first electrode plate 220 may act as a cathode, and the second electrode plate 230 may act as an anode. The first electrode plate 220 may be formed to slightly longer than the second electrode plate 230 in order to secure a sufficient space allowing lithium from the second electrode plate 230 as an anode to reach the first electrode plate 220 as a cathode. In other implementations, the first electrode plate 220 may be an anode and the second electrode plate 230 may be a cathode.

The case 300 accommodating the electrode assembly 200 may include a first subcase 310 and a second subcase 320.

The first subcase 310 may include an accommodating portion 311 accommodating the electrode assembly 200. The second subcase 320 may cover the first subcase 310. The accommodating portion 311 of the first subcase 310 may correspond to a shape and a size of the electrode assembly 200. The accommodating portion 311 may be manufactured through a deep drawing process, for example, of forming a hollow container without a joint.

The first subcase 310 and the second subcase 320 may be coupled by sealing the edges thereof. The edges of the first subcase 310 and the second subcase 320 may be heat-fused to be stably sealed. The electrode tab 210 may protrude outwardly from the case 310. An electrode tab film 213 may be mounted on the electrode tab 210 on a portion where the case 300 is heat-fused. In this embodiment, the case 300 is described as a pouch-type case. In other implementations various case types such as an angular case, a cylindrical case, or the like, may be used.

An electrolyte may be provided within the case 200 together with the electrode assembly 200 to facilitate transfer of a current or electric charges between the first electrode plate 220 and the second electrode plate 230. The electrolyte may include a lithium salt acting as a supply source of lithium ions and a nonaqueous organic solvent serving as a medium allowing ions participating in an electrochemical reaction to move.

FIG. 3 illustrates a cross-sectional view of the first electrode plate 220 of the electrode assembly 200 of the secondary battery 100 illustrated in FIG. 1. The first electrode plate 220 of the electrode assembly 200 of the secondary battery 100 according to this embodiment will be described with reference to FIG. 3.

As illustrated in FIG. 3, the first electrode plate 220 may include the first base material 221 having an end that is cut to be sloped and the first active material layer 222 having an end that is cut to be sloped. The first base material 221 may include a first region 221a and a second region 221b. The first active material layer 222 may be positioned in the first region 221a and may be absent from the second region 221b, exposing the first base material 221 so to provide a first uncoated portion 223. The first electrode tab 211 acting as a cathode tab may be welded to be connected to the first uncoated portion 223. The first electrode plate 220 may act as a cathode, for example, and the first base material 221 may act as a current collector and include a cathode plate formed as a thin film. The first active material layer 222 may be formed of a cathode active material including carbon. In some implementations, the first active material layer 222 may be positioned on both sides of the first base material 221. In other implementations, the first electrode plate 220 may be formed to be longer than the second electrode plate 230, and the first active material layer 222 in the vicinity of the end of the first electrode plate 220 may be positioned only on one surface of the first base material 222.

The end of the first base material 221 may be cut to be sloped. The first active material layer 222 may be positioned on the first base material 221. The end of the first active material layer 222 may be cut to be sloped in an opposite direction of the sloping direction of the first base material 221. Sloped tips of the first base material 221 and the first active material layer 222 may face each other. For example, the surface of the first base material 221 contacting the first active material layer 222 may extend farther than the opposite surface of the first base material, with a sloped surface between the contacting surface and opposite surface of the first base material 221. Similarly, the surface of the first active material layer 222 contacting the first base material 221 may extend farther than the opposite surface of the first active material layer 222, with a sloped surface between the contacting surface and opposite surface of the first active material layer 222. The slopes of the first base material 221 and the first active material layer 222 may each form an angle ranging from 10 to 80° with respect to a direction in which the first base material 221 extends.

If the ends of the first base material 221 and the first active material layer 222 were to be cut to be linear, for example, perpendicular to an extending direction of the first base material 221 and first active material layer 222, rather than being sloped, then when the corresponding ends overlap, stress could concentrate thereon due to expansion and contraction of the electrode plate generated during a charging and discharging process, causing cracks that could negatively affect battery performance. However, when the end of the first base material 221 and the end of the first active material layer 222 are cut to be sloped as in the present embodiment, even though the ends overlap, stress may be reduced. In particular, in this embodiment, the end of the first base material 221 and the end of the first active material layer 222 may be sloped to oppose each other. Accordingly, even though the ends may overlap, stress may be minimized.

When the electrode assembly 200 has a flat rectangular shape as illustrated in

FIG. 1, there the region on which stress concentrates may differ from that of a cylindrical electrode assembly. In particular, stress may concentrate on a shorter side portion 260 rather than on the longer side portion 250. When the end of the first electrode plate 220 is positioned in the shorter side portion 260, stress may concentrate on the end to cause cracks. However, when the ends of the first base material 221 and the first active material layer 222 are sloped, as in the embodiment, even though the end of the first electrode plate 220 is positioned in the shorter side portion 260 of the electrode assembly 200, relatively small stress may concentrate on the end, and thus, generation of cracks may be prevented.

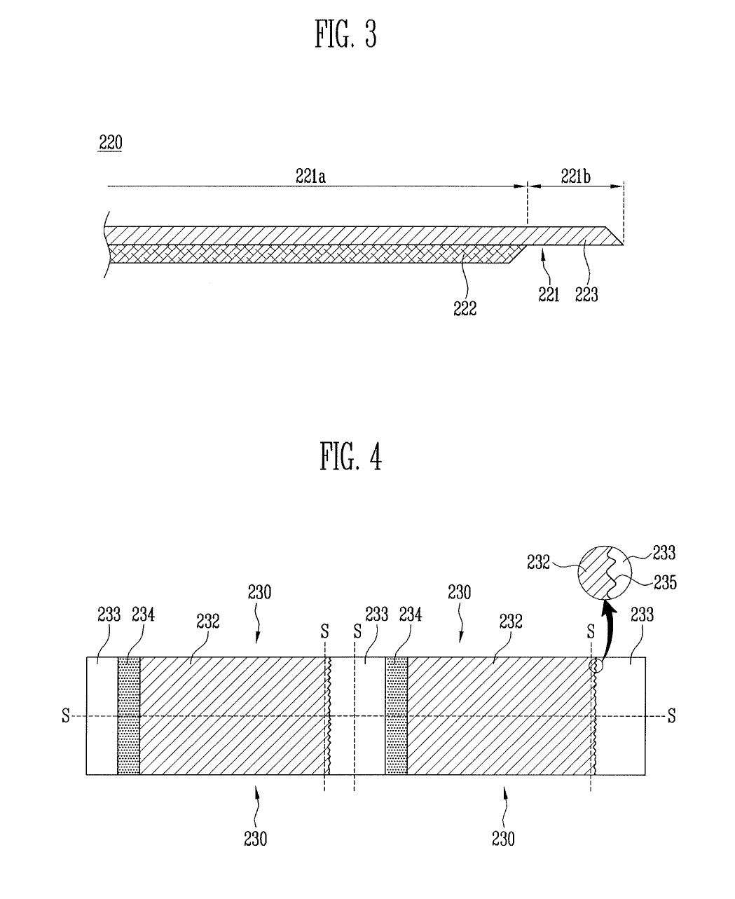

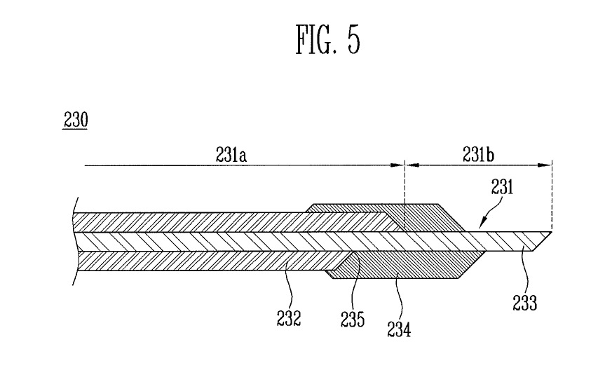

FIG. 4 illustrates a plan view of a process for manufacturing the second electrode plate 230 of the electrode assembly 200 of the secondary battery 100 illustrated in FIG. 1, and FIG. 5 illustrates a cross-sectional view of the second electrode plate 230 of the electrode assembly 200 of the secondary battery 100 illustrated in FIG. 1. Hereinafter, the second electrode plate 230 according to this embodiment will be described with reference to FIGS. 4 and 5.

Referring to FIG. 4, in order to manufacture the second electrode plate 230 as an anode, a process of forming a second active material layer 232 on a second base material 231 is performed. For example, the second active material layer 232 may be coated to be formed on the second base material 231 by using a coater. In this case, the second active material layer 232 may be intermittently coated on the second base material 231 for mass-production. A second uncoated portion 233 may be formed on the second base material 231 in which the second active material layer 232 is not coated. The second active material layer 232 may be in a slurry state with high viscosity before being dried. Accordingly. movement of the second active material layer 232 along the surface of the second base material 231 may occur in boundary portions 235 where coating of the second active material layer 232 starts and ends due to viscosity differences between the second active material layer 232 and the second base material 231, generating a waveform shape or configuration of the second active material layer 232 at the boundary portions 235 as seen in a plan view. The waveform shape at one side boundary portion 235 may be removed through a slitting (s) process that removes the second uncoated portion 233. However, at the other side boundary portion 235, the second uncoated portion 233 is not removed, and accordingly, waveform shape of the second active material layer 232 at the boundary portion 235 remains. In this case, there is a risk that the second active material layer 232 formed to have a waveform shape in the boundary portion 235 may be easily released or may peel away from the second base material 231 to come into contact with the first electrode plate 220 having a negative electrode, a different polarity, to cause a short-circuit, or the like, or contaminate the electrolyte to degrade performance of the secondary battery 100. Such a risk is greater with respect to a boundary portion 235 of second active material layer 232 as compared to a boundary portion of the first active material layer 222 due to the characteristics such as viscosity, or the like, of the anode slurry that make the waveform shape more likely to occur at the second electrode plate 230.

In order to prevent the separation of the second active material layer 232, a stacked member 234 may be provided to cover the boundary portion 235. As illustrated in FIG. 5, the second electrode plate 230 may include the second base material 231, the second active material layer 232 positioned on the second base material 231, and the stacked member 234 positioned on the second base material 231 to overlap the second active material layer 232, for example, positioned to cover the boundary portion 235. The stacked member 234 may be implemented as a lamination tape. Separation of the second active material layer 232 may be prevented by the stacked member 234. In some implementations, the stacked member 234 may also be included in the first electrode plate 220.

In the present embodiment, the second active material layer 232 and the stacked member 234 may be implemented to have sloped ends.

The second active material layer 232 and the stacked member 234 may be present on both sides of the second base material 231. All of the second base material 231, the second active material layer 232, and the stacked member 234 may have a shape cut to have a sloped end. The end of the second active material layer 232 may be cut such that a tip of the sloped surface thereof faces the second base material 231. Both ends of the stacked member 234 may have a sloped shape. In this case, one end of the stacked member 234 positioned on the second base material 231 may be sloped in a direction identical to the sloping direction of the second active material layer 232 and the other end thereof may be sloped in the opposite direction of the sloping direction of the second active material layer 232. For example, the slopes of the second base material 231, the second active material layer 232, and the stacked member 234 may each form an angle ranging from 10 to 80° with respect to a direction in which the second base material 231 extends. These shapes may prevent or reduce the likelihood of cracks being generated in the ends that overlap when the first electrode plate 220 and the second electrode plate 234 are wound.

The second active material layer 232 and the stacked member 234 may be positioned on both sides of the second base material 231. As illustrated in FIG. 5, an extended length of the second active material layer 232 and the stacked member 234 positioned on one surface of the second base material 231 and an extended length of the second active material layer 232 and the stacked member 234 positioned on the other surface of the second base material 231 may be different. The second base material 231 having the sloped surface may be cut such that the tip of the sloped surface thereof faces the tip of the sloped surface of the first base material 221 to have different sloping directions. Thus, when the first electrode plate 220, the separator 240, and the second electrode plate 230 in a stacked state are wound, a concentration of stress in the overlapping portion may be prevented or reduced.

The second base material 231 may be divided into a first region 231a and a second region 231b. The second active material layer 232 may be positioned in the first region 231a, and the second region 231b may be an uncoated portion 233. The second electrode tab 212, acting as an anode tab, may be welded to be connected to the second uncoated portion 233. The second base material 231 may act as a current collector and may include an anode plate formed as a thin film. The second active material layer 232 may be formed of an anode active material including lithium.

By way of summation and review, it is desirable for electronic devices to be small in size and light in weight, and accordingly. it is desirable for secondary batteries to also be small and light. However, secondary batteries may include materials having high reactivity, such as lithium, or the like, therein. Thus, there may be limitations in reducing a size and weight of secondary batteries in terms of stability. Thus, a secondary battery having enhanced stability is desirable.

Embodiments provide a secondary battery having enhanced stability by preventing the generation of cracks due to a concentration of stress. According to embodiments, ends of a first base material and a first active material layer are formed to be sloped to reduce stress in a portion where electrode plates overlap. The generation of cracks may be be prevented to enhance stability. According to embodiments, ends of the second base material, the second active material layer, and the stacked member are formed to be sloped, further reducing stress in the portion where electrode plates overlap.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope thereof as set forth in the following claims.

What is claimed is:

1. A secondary battery, comprising:
an electrode assembly including a first electrode plate, a second electrode plate facing the first electrode plate, and a separator between the first electrode plate and the second electrode plate; and
a case accommodating the electrode assembly,
wherein the first electrode plate includes a first base material having a sloped end and a first active material layer positioned on the first base material, the first active material layer having a sloped end.

2. The secondary battery as claimed in claim 1, wherein the sloped end of the first base material and the sloped end of the first active material layer are sloped at opposing angles to each other.

3. The secondary battery as claimed in claim 1, wherein the second electrode plate includes a second base material having a sloped end, a second active material layer on the second base material and having a sloped end, and a stacked member on the second base material partially overlapping the second active material layer and having a sloped end.

4. The secondary battery as claimed in claim 3, wherein the stacked member is a lamination tape.

5. The secondary battery as claimed in claim 3, wherein:
the stacked member includes a first sloped end and a second sloped end,
the first sloped end of the stacked member is located on the second base material and slopes in a direction identical to a sloping direction of the sloped end of the second active material layer, and
the second sloped end of the stacked member is located in an overlapping relationship to the second active material layer and slopes in a direction opposite to the sloping direction of the second active material layer.

6. The secondary battery as claimed in claim 3, wherein directions in which the sloped end of the first base material and the sloped end of the second base material slope are opposite to each other.

7. The secondary battery as claimed in claim 3, wherein the second active material layer and the stacked member are located on both sides of the second base material.

8. The secondary battery as claimed in claim 7, wherein an extending length of the second active material layer and the stacked member located on one surface of the second base material is different from an extending length of the second active material layer and the stacked member located on an opposite surface of the second base material.

9. The secondary battery as claimed in claim 1, wherein the first electrode plate, the second electrode plate, and the separator are in a wound state.

10. The secondary battery as claimed in claim 1, wherein a slope of sloped end of the first base material and a slope of the sloped end of the first active material layer each form an angle in the range of about 10° to about 80° with respect to a direction in which the first base material extends.

11. The secondary battery as claimed in claim 1, wherein an end of the first electrode plate is positioned at a shorter side portion among a longer side portion and the shorter side portion of the electrode assembly.

12. The secondary battery as claimed in claim 1, wherein:
the first base material includes a first region and a second region,
the first active material layer is located in the first region, and
the second region is a first uncoated portion.

13. The secondary battery as claimed in claim 3, wherein:
the second base material includes a first region and a second region,
the second active material layer is located in the first region, and
the second region is a second uncoated portion.

14. The secondary battery as claimed in claim 13, wherein a boundary between the second active material layer and the second uncoated portion has a waveform shape.
